(19) United States
(12) Patent Application Publication
(10) Pub. No.: US 2004/0057650 A1
(43) Pub. Date: Mar. 25, 2004

(54) Apparatus and method for monitoring characteristics of pharmaceutical compositions during preparation in a fluidized bed

(76) Inventor: Staffan Folestad, Molndal (SE)

Correspondence Address: WHITE & CASE LLP, PATENT DEPARTMENT, 1155 AVENUE OF THE AMERICAS, NEW YORK, NY, 10036, US

(21) Appl. No.: 10/399,575

(22) PCT Filed: Oct. 16, 2001
(86) PCT No.: PCT/SE01/02266

(30) Foreign Application Priority Data
Oct. 20, 2000 (SE) 0003796-0

(51) Int. Cl. G02B 6/12

(52) U.S. Cl. 385/14

(57) ABSTRACT

The present invention relates to a method and apparatus for monitoring characteristics of a pharmaceutical composition during preparation thereof by in the process vessel (1) of a fluidized bed apparatus, wherein a measuring device (11, 11′) performs a spectometric measurement on the pharmaceutical composition in a wetting zone (B) into which a processing fluid is injected. The method also comprises the generic use of an optical probe device in spectrometric measurements, the probe device being capable of transmitting a two-dimensional image of radiation emitted from a monitoring area in the process vessel (1).

### FIELD OF THE INVENTION

The present invention relates to an apparatus and methods for monitoring characteristics of pharmaceutical compositions during preparation thereof. The invention is particularly concerned with preparation by a particle-forming process in a fluidized bed apparatus, wherein particle growth takes place either by coalescence of two or more particles, termed agglomeration, or by deposition of material onto the surface of single particles, termed surface layering or coating. However, the invention is also applicable in connection with other preparation, such as mixing processes or other types of coating processes.

The present invention is especially useful in connection with coating processes. Therefore, the technical background of the invention, and objects and embodiments thereof, will be described with reference primarily to such coating processes, without the invention being limited thereto.

### TECHNICAL BACKGROUND

Pharmaceutical products are coated for several reasons. A protective coating normally protects the active ingredients from possible negative influences from the environment, such as for example light and moisture but also temperature and vibrations. By applying such a coating, the active substance is protected during storage and transport. A coating could also be applied to make the product easier to swallow, to provide it with a pleasant taste or for identification of the product. Further, coatings are applied which perform a pharmaceutical function such as conferring enteric and/or controlled release (modified release). The purpose of a functional coating is to provide a pharmaceutical preparation or formulation with desired properties to enable the transport of the active pharmaceutical substance though the digestive system to the region where it is to be released and/or absorbed. A desired concentration profile over time of the active substance in the body may be obtained by such a controlled course of release. An enteric coating is used to protect the product from disintegration in the acid environment of the stomach. Moreover, it is important that the desired functionalities are constant over time. i.e. during storage. By controlling the quality of the coating, the desired functionalities of the final product may also be controlled.

A coating process, as well as an agglomeration process, can be effected in a circulating fluidized bed apparatus, for example of the Wurster type or the top-spray type, the operating parameters of the apparatus being chosen such that one of the particle-forming processes dominates over the other. Typically, four regions can be identified in a circulating fluidized bed apparatus: an upbed region, a deacceleration region, a downbed region and a horizontal transport region. In the upbed region, generally located at the axial center line of the process vessel, the particles are conveyed upwardly by a vertical gas flow. In the deacceleration region, the particles are retarded and moved into the downbed region, generally located at the periphery of the vessel, where the retarded particles move down by action of gravity. In the horizontal transport region, the particles are conveyed back to the upbed region. A more detailed description is found in the article “Qualitative Description of the Wurster-Based Fluid-Bed Coating Process”, published in Drug Development and Industrial Pharmacy 23(5), pp 451-463 (1997).

The above-mentioned particle-forming processes include a wetting phase in which a solution is applied to the particles, and a drying phase, in which the solution is allowed to solidify on the particles. In coating processes, as well as agglomeration processes, the solution is applied to the particles, typically in the form of a spray mist of droplets, in a wetting zone which normally includes at least part of the upbed region. The drying phase is then effected in a drying zone including the deacceleration region, the downbed region and the horizontal transport region.

Similarly, one or more wetting zones and one or more drying zones can be identified in the process vessel of other types of particle-forming fluidization equipment used for preparation of pharmaceutical compositions, wherein the wetting zone(s) can partially overlap the drying zone(s).

There are strict requirements from the different Registration Authorities on pharmaceutical products. These requirements will put high demands on the quality of pharmaceutical compositions and require that the complex properties thereof are kept within narrow limits. In order to meet these demands, there is a need for accurate control of processes for preparation of pharmaceutical compositions.

WO 99/32872 discloses a device for on-line analysis of material in a process vessel. The device comprises a sample collector for physically collecting a sample of the material, a spectroscopic measuring device for taking measurements from the collected sample, and sample displacing means for displacing the collected sample from the sample collector.

WO 00/03229 discloses a method of directly measuring and controlling a process of manufacturing a coating on a pharmaceutical product in a process vessel, by performing a spectrometric measurement on the coating, by evaluating the results to extract information directly related to the quality of the coating, and by controlling the process on basis, at least partly, of the information. Thus, this known method provides for in-line adjustments of the coating process based on spectrometric measurements such as those based on NIRS (Near Infrared Spectrometry), Raman scattering, absorption in the UV, visible or infrared (IR) wavelength regions, or luminescence such as fluorescence emission.

However, the process control resulting from a combination of the above teachings has, at least in some cases, given inadequate results. More specifically, with respect to the fluidized bed apparatus, it has been found that stagnant zones adjacent to the peripheral wall, as well as segregation of the material within the vessel, affect the reliability and accuracy of the extracted information and thereby also the control. This fact can be partly alleviated by making the sample collector movable within the process vessel, as disclosed in the above WO 99/32872. However, there is still a need for an improved apparatus and method for monitoring characteristics of pharmaceutical compositions during preparation in a process vessel, in particular of a fluidized bed apparatus.

### SUMMARY OF THE INVENTION

It is a general aim of the present invention to provide an improved apparatus and method for monitoring characteristics of a pharmaceutical composition during preparation thereof in a process vessel, in particular of a fluidized bed apparatus. It is a further object to provide for accurate control of the processes for preparation of pharmaceutical compositions.

These objects are, at least partially, achieved by an apparatus and methods according to the accompanying independent claims. Preferred embodiments are set forth in the dependent claims.

The present invention is based on the insight that, in a fluidized bed apparatus, is contrary to the common thinking in the present technical field, a spectrometric measurement is preferably performed in the wetting zone, instead of exclusively in the drying zone. Thus, information related to physical and/or chemical properties of the pharmaceutical composition, for example the quality of a coating, can be extracted from the very area in the process vessel where the particle-forming process is initiated by the injection of the processing fluid. In a fluidized bed apparatus, the wetting zone normally includes at least part of the upbed region, in which single objects are conveyed upwardly at high speed. Thus, the invention allows for remote analysis of single or multiple objects at the location where the processing fluid interacts with the material in the process vessel. Undesirable deviations from normal can be detected at an early stage and be corrected accordingly. Further, since a powerful and directional gas flow generally is established in the wetting zone, the risk-of stagnant zones and segregation affecting the measurement is minimized.

It is to be understood, however, that the inventive measurements in one or more wetting zones of the process vessel could be supplemented by measurements in one or more drying zones, or in any other zones of the process vessel.

Preferably, the process is controlled on basis, at least partly, of the information extracted from the spectrometric measurement. The invention is most effective in providing information for feedback control applied to the conditions within the process vessel.

The term “processing fluid” is used as a comprehensive expression encompassing everything from a pure liquid to a slurry or suspension of a liquid and solids. Alternatively, the processing fluid could be a mixture of solids and a carrier gas. In the latter case, the wetting zone denotes the region in which solids are deposited on the material in the process vessel.

The spectrometric measurement in the wetting zone is preferably remote, i.e. physical interference with the material in the vessel should be avoided, to minimize any influence on the particle-forming process. To this end, the spectrometric measurement is preferably effected by directing an excitation beam of coherent radiation, such as laser radiation, preferably pulsed laser radiation, to the monitoring area in the welting zone. The use of pulsed excitation radiation allows for “snapshot” detection of emitted radiation, for example by performing a time-gated detection of emitted radiation in time-synchronism with the excitation of the object(s). This time-gated detection is effected on a time scale that is short compared with the speed of the object(s). Thereby, the emitted radiation can be detected during a time period that is short enough to freeze any motion of the object(s). However, it should be noted that non-coherent radiation could be used instead of coherent radiation. In this connection, it should also be stated that the term “emitted” should be interpreted as re-emitted, i.e. resulting from absorption and/or elastic or inelastic scattering of the excitation radiation by the object(s). Similarly, the term “excitation” should be interpreted as meaning “illumination”, i.e. chemical excitation of an object in the monitoring area is not necessary, although possible.

The term “monitoring area” is generally intended to denote a region or volume in the process vessel, the region generally being defined by the imaged area and the depth of field of the measuring device.

In one preferred embodiment, use is made of an optical probe device which is capable of transmitting at least one two-dimensional image of the monitoring area (the emitted radiation) to a detection means. Preferably, the optical probe device is also capable of directing an excitation beam of radiation to the monitoring area. Thereby, only one probe is necessary for accessing the monitoring area in the process vessel. This is an advantage in situations where the monitoring area is difficult to approach physically.

In one further embodiment, the proximal end of the probe is provided with a hydrophilic coating, for minimizing any undesired deposition of processing fluid on the exposed proximal end of the device. Alternatively, or additionally, a gas flusher could be provided to generate a flow of gas over the exterior of the proximal end.

In another preferred embodiment, an imaging system is arranged at the proximal end of the probe device and optically coupled to an image-guiding optical fiber element. By making the imaging system adjustable with respect to the size of the monitoring area and/or the focal length, the probe can be remotely operated and readily adjusted to any particular measurement situation.

In a further preferred embodiment, the optical probe device has an excitation beam transmitting optical fiber assembly which extends from the proximal end and comprises single optical fibers arranged in at least one annulus at the proximal end. Thereby, uniform and diffuse illumination of the monitoring area is achieved. Preferably, the at least one annulus is concentric with the imaging system and arranged radially outside the perimeter of the imaging system, as seen towards the proximal end. This construction provides for a compact probe device having a large numerical aperture.

It should be emphasized that the optical probe device is generally applicable for monitoring physical and/or chemical properties of a pharmaceutical composition during preparation thereof in a more or less closed process vessel. In addition to the above-mentioned coating and agglomeration processes, such preparation could for example include mixing processes. The optical probe device could be used for effecting spectrometric measurements either in a remote mode, i.e. without physical contact between the probe and the material in the vessel, or in a contact mode, i.e. with physical contact between the probe and the material.

In the context of the present application, the term “remote” typically refers to a distance between the probe end and the monitoring area of about 1-200 cm. It should also be emphasized that the general option for remote analysis according to the invention is advantageous in that any physically inaccessible regions of any process vessel can be monitored. Remote analysis is also advantageous when the material in the process vessel is sticky or hostile.

It is conceivable to use essentially any spectrometric measurement technique, such as NIRS (Near Infrared Spectrometry), Raman scattering, absorption in the UV, visible or infrared (IR) wavelength regions, or luminescence such as fluorescence emission.

The two-dimensional images that are directed by the optical probe device from the monitoring area to the detection means could be analyzed in any one of a multitude of different ways, to yield different information on the concurrent preparation of the pharmaceutical composition. The extracted information is related to physical and/or chemical properties of the pharmaceutical composition, such as content, concentration, structure, homogeneity, etc.

The two-dimensional images could be used to analyze a single object, such as a particle, in the process vessel. Alternatively, a number of such objects could be analyzed simultaneously so that variations between individual objects are detectable from the image.

Thus, local inhomogeneities with respect to physical and/or chemical properties could be measured in one or more objects. For example, it is possible to extract measurement signals representative of the three-dimensional distribution of one or more components in the object, if the emitted radiation contains reflected radiation from a sufficient depth in the monitored objects.

Further, by detecting a number of two-dimensional images, each containing radiation at a unique wavelength or wavelength band, the intensity of the emitted radiation can be analyzed as a function of wavelength in two spatial dimensions.

Alternatively, or additionally, the information in each image could be used for analysis as a function of wavelength in one spatial dimension.

In another implementation, the information in each image, or in a portion thereof, could be integrated for analysis of intensity as a function of wavelength.

According to a specific aspect of the invention, the intensity of the emitted radiation from the monitoring area is detected as a function of both the wavelength of the emitted radiation and the photon propagation time through the monitoring area. This aspect of the invention is based on the following principles. An object to be analyzed by a spectrometric reflection and/or transmission measurement presents a number of so called optical properties. These optical properties are (i) the absorption coefficient, (ii) the scattering coefficient and (iii) the scattering anisotropy. Thus, when the photons of the excitation beam propagate through the monitoring area—in reflection and/or transmission mode—they are influenced by these optical properties and, as a result, subjected to both absorption and scattering. Photons that by coincidence travel along an essentially straight path through the object(s) in the monitoring area and thus do not experience any appreciable scattering will exit the monitoring area with a relatively short time delay. Photons that are directly reflected on the irradiated surface of the object(s) will also present a relatively short time delay, in the case of measurements on reflected radiation. On the other hand, highly scattered photons (reflected and/or transmitted) exit with a longer time delay. This means that all these emitted photons—presenting different propagation times—mediate complementary information about the object(s) in the monitoring area.

In a conventional steady state (no time-resolution) measurement, some of that complementary information is added together since the emitted radiation is captured by a time-integrated detection. Accordingly, the complementary information is lost in a conventional technique. For instance, decrease in the registered radiation intensity may be caused by an increase in the absorption coefficient of the object, but it may also be caused by a change in the scattering coefficient of the object. However, the information about the actual cause is hidden, since all the emitted radiation huts been time-integrated.

According to this aspect of the invention and in contrast to such prior-art NIR spectroscopy with time-integrated intensity detection, the intensity of the emitted radiation from the object(s) is measured both as a function of the wavelength and as a function of the photon propagation time through said object(s). Thus, the inventive method according to this aspect can be said to be both wavelength-resolved and time-resolved. It is important to note that the method is time-resolved in the sense that it provides information about the kinetics of the radiation interaction with the object(s). Thus, in this context, the term “time resolved” means “photon propagation time resolved”. In other words, the time resolution used in the invention is in a time scale which corresponds to the photon propagation time in the object(s) (i.e. the photon transit time from the source to the detection unit) and which, as a consequence, makes it possible to avoid time-integrating the information relating to different photon propagation times. As an illustrative example, the transit time for the photons may be in the order of 0,1-2 ns. Especially, the term “time resolved” is not related to a time period necessary for performing a spatial scanning, which is the case in some prior-art NIR-techniques where “time resolution” is used.

As a result of not time-integrating the radiation (and thereby “hiding” a lot of information) as done in the prior art, but instead time-resolving the information from the excitation of the object(s) in combination with wavelength-resolving the information, this aspect of the invention makes it possible to establish quantitative analytical parameters of the object(s), such as content, concentration, structure, homogeneity, etc.

Both the transmitted radiation and the reflected radiation from the irradiated object(s) comprise photons with different time delay. Accordingly, the time-resolved and wavelength-resolved detection may be performed on reflected radiation only transmitted radiation only, as well as a combination of transmitted and reflected radiation.

The excitation beam of radiation used in the present aspect may include infrared radiation, especially near infrared (NIR) radiation in the range corresponding to wavelengths of from about 700 to about 2500 nm, particularly from about 700 to about 1300 nm. However, the excitation beam of radiation may also include visible light (400 to 700 nm) and UV radiation.

Preferably, the step of measuring the intensity as a function of photon propagation time is performed in time-synchronism with the excitation of the object(s). In a first preferred embodiment, this time synchronism is implemented by using a pulsed excitation beam, presenting a pulse train of short excitation pulses, wherein each excitation pulse triggers the intensity measurement. To this end, a pulsed laser system or laser diodes can be used. This technique makes it possible to perform a photon propagation time-resolved measurement of the emitted intensity (reflected and/or transmitted) for each given excitation pulse, during the time period up to the subsequent excitation pulse.

In order to avoid any undesired interference between the intensity measurements relating to two subsequent excitation pulses, such excitation pulses should have a pulse length short enough in relation to the photon propagation time in the object(s) and, preferably, much shorter than the photon propagation time.

To summarize, in this first embodiment of this specific aspect, the intensity detection of the emitted radiation associated with a given excitation pulse is time-synchronized with this pulse, and the detection of the emitted radiation from one pulse is completed before the next pulse.

The data evaluation can be done in different ways. By defining the boundary conditions and the optical geometry of the set-up, iterative methods such as Monte Carlo simulations can be utilized to calculate the optical properties of the object(s) and indirectly content and structural parameters. Alternatively, a multivariate calibration can be used for a direct extraction of such parameters. In multivariate calibration, measured data is utilized to establish an empirical mathematical relationship to the analytical parameter of interest, such as the content or structure of a pharmaceutical substance. When new measurements are performed, the model can be used to predict the analytical parameters of the unknown object(s).

In an alternative second embodiment, the radiation source, for example a laser or a lamp, is intensity modulated in time. Then, frequency-domain spectroscopy can be used for determining phase shift and/or modulation depth of the emitted radiation from the object(s). Thus, the phase and/or modulation depth of the emitted radiation is compared with that of the excitation radiation. That information can be used to extract information about the lime delay of the radiation in the object(s). It should be noted that such a frequency-domain spectroscopy is also a “time-resolved” technique according to the invention, since it also provides information about the kinetics of the photon interaction with the object(s). With similar mathematical procedures as above, the same quantitative analytical information can be extracted.

A pulsed excitation beam according to the first embodiment, and an intensity modulated excitation beam according to the second embodiment, share the common feature that they make it possible to identify—in said excitation beam—a specific “excitation time point” which can be used to trigger the detection of the emitted radiation from the object(s), i.e. to time-synchronize the time-resolved detection with the excitation of the object(s). This can be performed by letting the pulsed or modulated beam trigger a photodetector or the equivalent, which in its turn triggers the detection unit via suitable time-control circuitry.

The time-resolved detection may be implemented by the use of a time-resolved detector, such as a streak camera. It may also be implemented by the use of a time-gated system, by which the detection of emitted radiation is performed during a limited number of very short time slices instead of the full time course. The time length of each such time slice is only a fraction of the detection time period during which the time-resolved detection is performed for each excitation. By measuring several such “time slices” a coarse time resolution is achieved. An attractive alternative is to measure wavelength-resolved spectra at two such time gates, prompt radiation and delayed radiation. Furthermore, time-resolved data may be recorded by means of other time-resolved equipment, transient digitizers or equivalent.

The wavelength-resolved detection may be implemented in many different, conventional ways. It may be implemented by the use of one or more single-channel detectors for selecting one or more wavelengths, such as ultrafast photo diodes, photomultipliers, etc. or by the use of a multi-channel detector, such as a microchannel plate or a streak camera. Use can be made of radiation dispersive systems, such as (i) a spectrometer, (ii) a wavelength dependent beam splitter, (iii) a non-wavelength dependent beam splitter in combination with a plurality of filters for filtering each of respective components for providing radiation of different wavelength or wavelength band, (iv) a prism array or a lens system separating the emitted radiation from the monitoring area into a plurality of components in combination with a plurality of filters, etc.

### DESCRIPTION OF THE DRAWINGS

FIG. 1 illustrates a known circulating fluidized bed apparatus of the Wurster type, provided with an measuring device operating according to the invention.

FIGS. 2a and 2b is a side view and an end view, respectively, of an optical probe device for use in the apparatus and methods of the invention.

FIG. 3 is a schematic side view illustrating the installation of the probe device of FIG. 2 in a general fluidization apparatus.

FIG. 4 shows a set-up for performing a time-resolved and wavelength-resolved analysis, and is intended to illustrate the principles of the specific aspect of the inventive methods.

FIG. 5 is a streak camera image, illustrating an experimental result of a wavelength-resolved and time-resolved transmission measurement, for illustration of the principles of the specific aspect of the inventive methods.

FIG. 6 is a diagram illustrating experimental results from measurements on two different objects.

FIG. 7 is a streak camera image, illustrating an experimental result of a time-resolved transmission measurement, in combination with spatial resolution.

FIG. 8 illustrates alternative use of data obtained by an optical probe device according to the invention.

FIG. 9 is a schematic side view illustrating a convective powder blender provided with an optical probe device according to the invention.

FIG. 10 is a schematic side view illustrating an intensive blender for wet granulation with an optical probe device according to the invention.

### DETAILED DESCRIPTION OF THE INVENTION

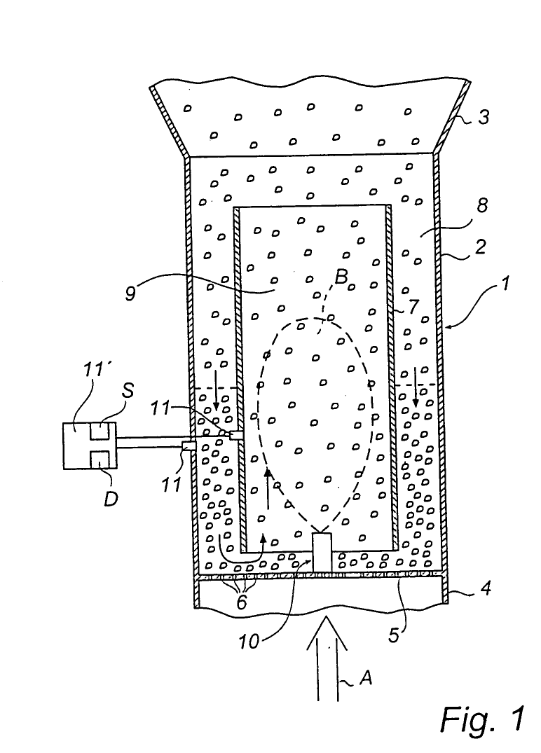

For the purpose of illustrating the type of situations in which the invention could be applied, a known circulating fluidized bed apparatus will be described with reference to FIG. 1. More specifically, FIG. 1 shows a fluidized bed apparatus of the Wurster type designed to provide a coating on a batch of objects, such as tablets, capsules or pellets, thereby producing a pharmaceutical composition with desired characteristics. The apparatus comprises a process vessel 1 having a product container section 2, an expansion chamber 3 into which the upper end of the product container section 2 opens, and a lower plenum 4 disposed beneath the product container section 2, separated therefrom through the utilization of a gas distribution plate or screen 5. The screen 5 defines a plurality of gas passage openings 6 through which air or gas (indicated by arrow A) from the lower plenum 4 may pass into the product container section 2.

The product container section 2 has a cylindrical partition or Wurster column 7 supported therein in any convenient manner having open upper and lower ends, the lower end being spaced above the screen 5. The partition 7 divides the interior of the product container section 2 into an outer annular downbed region 8 and and interior upbed region 9. A spray nozzle 10 is mounted on the screen 5 and projects upwardly into the interior of the cylindrical partition 7 and the upbed region 9 defined therein. The spray nozzle 10 typically receives a supply of gas under pressure through a gas supply line (not shown) and coating liquid under pressure through a liquid supply line (not shown), as is known in the art. The spray nozzle 10 discharges a spray pattern of gas and coating liquid into the upbed region, thereby forming a wetting zone B therein.

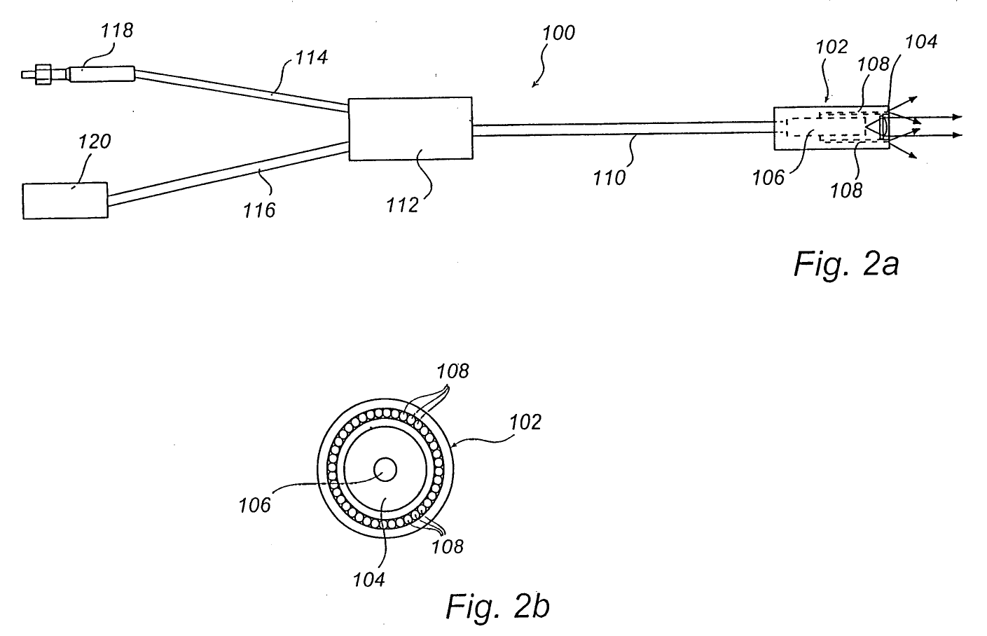

The apparatus of FIG. 1 is provided with a measuring device, preferably including an optical probe device to be described below with reference to FIGS. 2a-2b. The measuring device comprising a terminal probe unit 11 and a base unit 11′ which in turn includes a radiation source S and a detection means D. The terminal probe unit 11 is illustrated in two possible mounting positions: in a wall portion of the product container section 2, and in a wall portion of the partition 7, in both positions for performing a spectrometic measurement of physical and/or chemical properties of the pharmaceutical composition during preparation thereof.

In operation, the apparatus fluidizes the objects on the flow A of air or gas and conveys them in a circular path within the process vessel 1, thereby passing the objects through the wetting zone B in the upbed region 9, a deacceleration region in the expansion chamber 3, the downbed region 8 and a horizontal transport region above the screen 5, and back to the upbed region 9.

The operation of the apparatus can be controlled on the basis, at least partly, of information extracted from such a spectrometric measurement, by means of the base unit 11′ operating as a controller, for example according to the method disclosed in the applicant's international application with publication number WO 00/03229, which is incorporated herein by reference.

FIGS. 2a-2b show an optical probe device 100 for use in connection with the present invention. The probe 100 is designed to transmit excitation radiation from a distal end to a proximal end, for diffuse illumination of a monitoring area, and to transmit an image of the monitoring area from the proximal end to the distal end. The probe comprises an imaging head 102 (corresponding to the terminal probe unit 11 in FIG. 1) at the proximal end thereof. The imaging head 102 includes a lens assembly 104 which is optically coupled to a coherent image guide bundle 106. The lens assembly 104 is adjustable with respect to size of the monitoring area and distance thereto. The imaging head 102 also includes excitation fibers 108, the ends of which are arranged in a ring-shaped pattern at the proximal end face of the head 102. As shown in the end view of FIG. 2-b, the ring-shaped pattern of fiber ends is concentric with the, lens assembly 104. The excitation fibers 108 and the image guide bundle 106 extend, in a common sheathing 110, from the head 102 to a branching unit 112, where they are divided into an excitation leg 114 and an imaging leg 116 having connectors 118, 120 for connection to the radiation source S and the detection means D, respectively (FIG. 1).

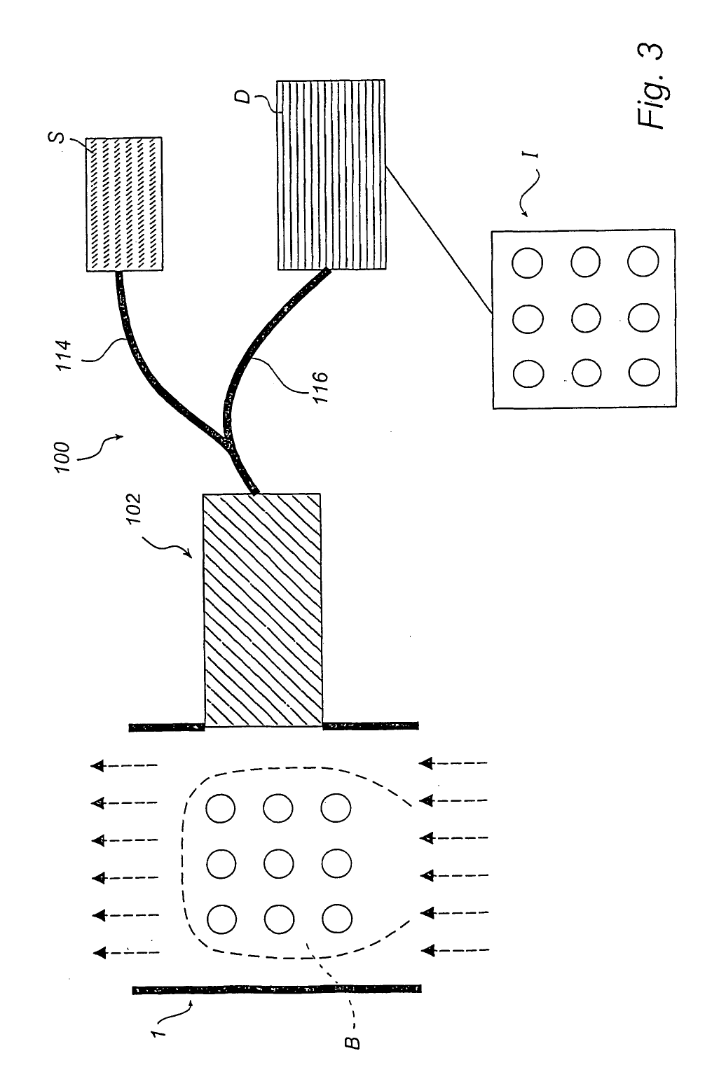

FIG. 3 shows a typical installation of the optical probe device 100 of FIG. 2 in the process vessel of a particle-forming fluidization apparatus, for example the apparatus of FIG. 1. The optical head 102 is installed in a wall portion of the Wurster column 7 in the process vessel 1 for remote monitoring of the spray zone B, through which objects are conveyed by a gas flow (indicated with arrows). The excitation leg 114 is connected to the radiation source S, typically emitting coherent radiation, such as laser radiation. The detection means D is connected to the imaging leg 116.

In operation, the radiation source S emits an excitation beam of radiation which is directed by means of the probe 100 to the monitoring area in the wetting zone B. Radiation re-emitted from the monitoring area is then, by means of the probe 100, directed to the detection means D as a two-dimensional image 1 of the monitoring area. After detection, data related to the image 1 is subsequently processed in a data processor (not shown) for extraction of physical and/or chemical properties of the object(s) in the monitoring area, for example by multivariate analysis such as disclosed in the above-identified international application WO 00/03229.

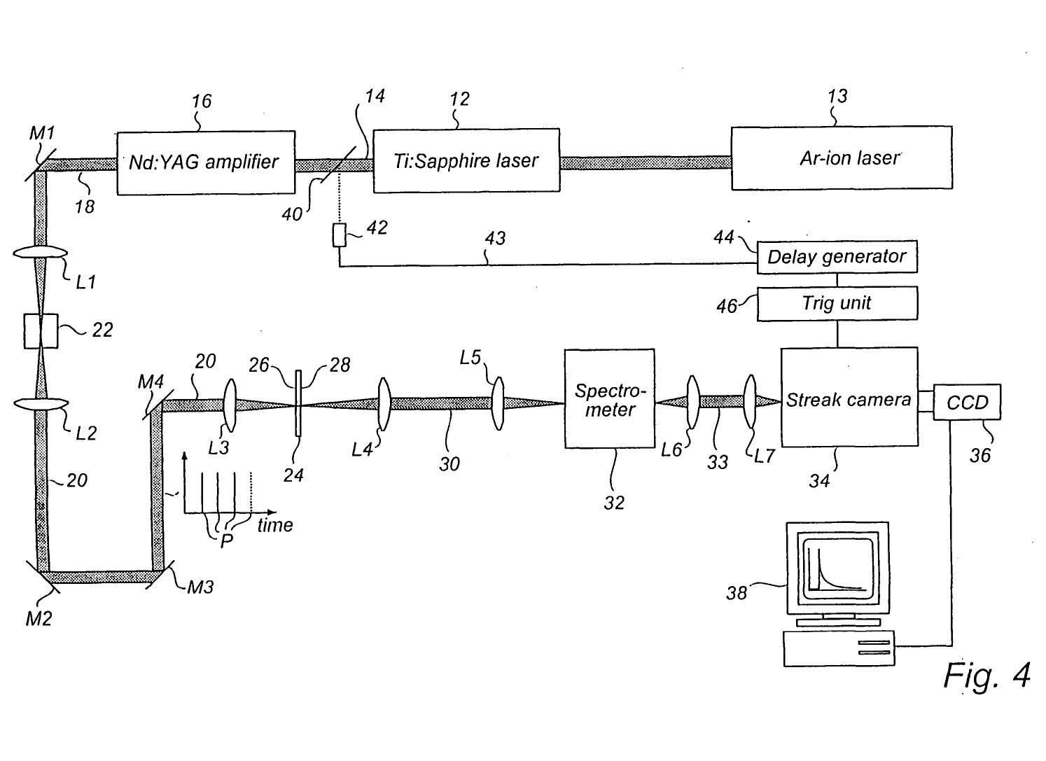

FIG. 4 shows a set-up for performing a time-resolved and wavelength-resolved analysis. The set-up is intended to illustrate the principles of a specific aspect of the invention, and for reasons of simplicity the illustrated set-up is based on transmission measurements on a fixed object. The arrangement in FIG. 4 comprises a Ti:Sapphire laser 12 pumped by an argon ion laser 13. The laser beam 14 thereby generated is amplified by a neodymium YAG amplifier stage 16 into an amplified laser beam 18. In order to create an excitation beam 20 of “white” radiation, i.e. broadband spectral radiation, the laser beam 18 is passed through a water-filled cuvette 22 via a mirror M1 and a first lens system L1.

An object to be analyzed is schematically illustrated at reference numeral 24 and comprises a front surface 26 and a back surface 28. The excitation laser beam 20 is focused onto the front surface 26 of object 24 via a lens system L2/L3 and mirrors M2-M4. On the opposite side of object 24, the transmitted laser beam 30 is collected from the backside by lens system L4/L5 and focused into a spectrometer 32.

As schematically illustrated in FIG. 4, the excitation beam 20 in this embodiment is time-pulsed into a pulse train of short, repetitive excitation pulses P. The pulse length of each excitation pulse P is short enough and the time spacing between two consecutive excitation pulses P is long enough in relation to the transit time of the beam (i.e. in relation to the time taken for each pulse to be completely measured in time), such that any interference is avoided between the detected radiation from one given excitation pulse Pn and the detected radiation from the next excitation pulse Pₙ₊₁. Thereby, it is possible to perform a time-resolved measurement on the radiation from one excitation pulse P at a time.

From the spectrometer 32, the wavelength-resolved beam 33 is passed via lens u system L6/L7 to a time-resolved detector, which in this embodiment is implemented as a streak camera 34. The streak camera 34 used in an experimental set-up according to FIG. 4 was a Hamamutsu Streak Camera Model C5680. Specifically, the streak camera 34 has an entrance slit (not shown) onto which the wavelength-resolved beam 33 from the spectrometer 32 is focused. It should be noted that only a fraction of the radiation emitted from the object is actually collected in the spectrometer 32 and, thereby, in the detector 34.

As a result of passing through the spectrometer 32, the emitted radiation 30 from the object 24 is spectrally divided in space, such that radiation received by the streak camera 34 presents a wavelength distribution along the entrance slit.

The incident photons at the slit are converted by the streak camera into photoelectrons and accelerated in a path between pairs of deflection plates (not shown). Thereby, the photoelectrons are swept along an axis onto a microchannel plate inside the camera, such that the time axis of the incident photons is converted into a spatial axis on said microchannel plate. Thereby, the time in which the photons reached the streak camera and the intensity can be determined by the position and the luminance of the streak image. The wavelength-resolution is obtained along the other axis. The photoelectron image is read out by a CCD device 36, which is optically coupled to the streak camera 34. The data collected by the CCD device 36 is coupled to an analyzing unit 38, schematically illustrated as a computer and a monitor.

In the set-up in FIG. 4, the intensity of the emitted radiation is measured as a function of time in time-synchronism with each excitation of the object. This means that the detection unit comprising the streak camera 34 and the associated CCD device 36 is time-synchronized with the repetitive excitation pulses P. This time-synchronism is accomplished as follows: each excitation pulse P of the laser beam 14 triggers a photodetector 42 or the equivalent via an optical element 40. An output signal 43 from the photodetector 42 is passed via a delay generator 44 to a trig unit 46, providing trig pulses to the streak camera 34. In this manner, the photon detection operation of the streak camera is activated and de-activated at exact predetermined points of time after the generation of each excitation pulse P.

As mentioned above, the evaluation and analysis of the collected, time-resolved information can be done in different ways. As schematically illustrated in FIG. 4, the collected data information from each excitation is transferred from the streak camera 34 and the CCD device 36 to a computer 38 for evaluation of the information. Monte Carlo simulations, multivariate calibrations, etc as mentioned in the introductory part of this application can be utilized in order to calculate the optical properties of the object and, indirectly, content and structural parameters of the object 24.

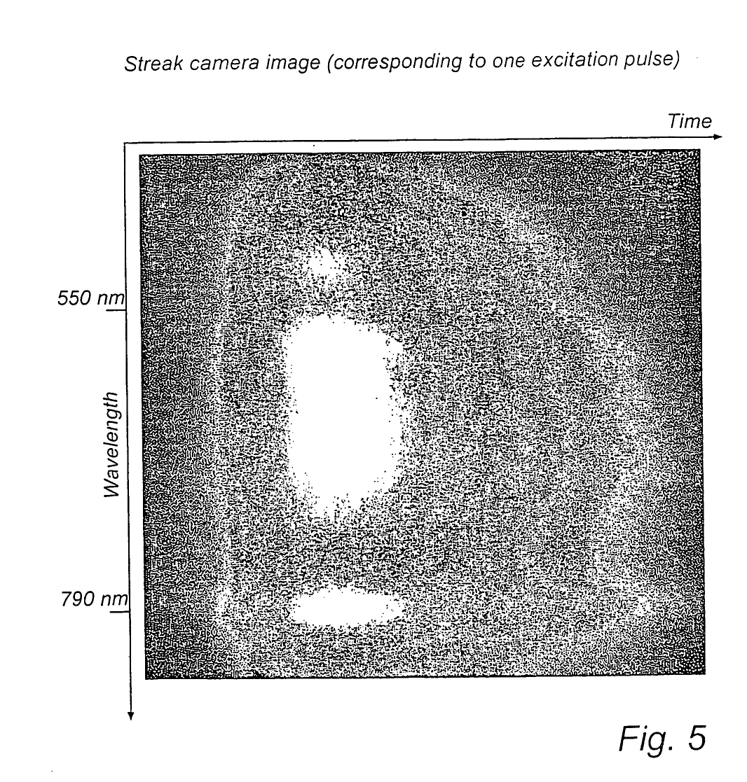

The cuvette 22, which contains water or any other suitable substance producing white laser radiation in combination with the spectrometer 32 acting as a wavelength-dispersive clement makes it possible to collect data that is both wavelength-resolved and time-resolved. FIG. 5 illustrates the experimental result of such a detection. It should be noted that the time scale in FIG. 5 illustrates the intensity variation over time for one pulse only, although the actual data used for producing these figures is based on accumulated data from many readings. The time axis in FIG. 5 is in nanosecond scale. The light portions in FIG. 5 correspond to high intensity values. The left part of the image corresponds to detected photons having a relatively short time delay, whereas the right part of the image corresponds to photons with a relatively long delay time. Thus, the time-resolved spectroscopy according to the specific aspect of the invention results in an intensity measurement as a function of both wavelength and photon propagation time. From FIG. 5 it is also clear that the total information content as obtained by the present invention is significantly greater than the information obtainable with a conventional time-integrated detection.

In FIG. 5, for each wavelength there is a multitude of timely spaced intensity readings. Thus, for each wavelength it is possible to obtain a full curve of emitted intensity vs. propagation time. The form of these “time profiles” is dependent on the relation between the optical properties of the analyzed object. With such a time-resolved and wavelength-resolved spectroscopy, it is possible to obtain information for describing the radiation interaction with the object.

It is also possible to evaluate the emitted radiation by detecting the intensity during fixed time slices. This would give a more coarse time resolution. In one embodiment, wavelength-resolved spectra are measured at two time gates only—one for “prompt” radiation and one for “delayed” radiation.

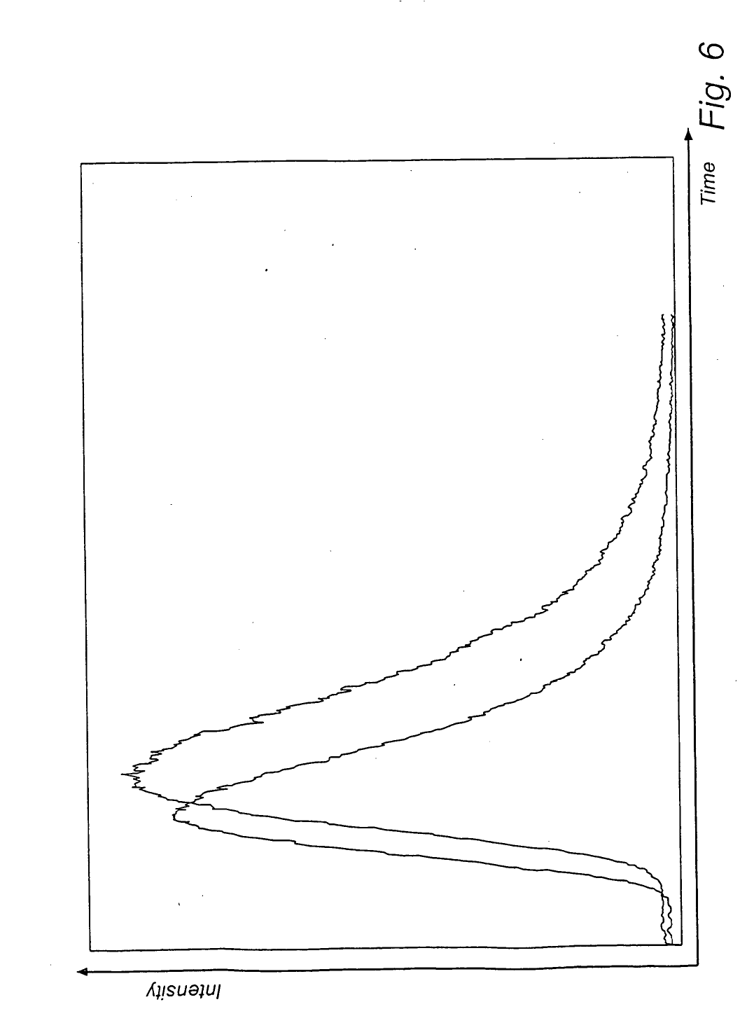

The intensity-time diagram in FIG. 6 illustrates two experimental, time-resolved results from measurements on two different objects. By selecting suitable time gates where the difference is substantial, one can easily distinguish different objects from each other.

As an alternative to the set-up illustrated in FIG. 4, instead of using the water cuvette 20 in combination with the spectrometer 32, is possible to use wavelength selective radiation sources, such as diode lasers. On the detector side, wavelength selective detectors, such combinations of filters and detector diodes, can be used for-each wavelength.

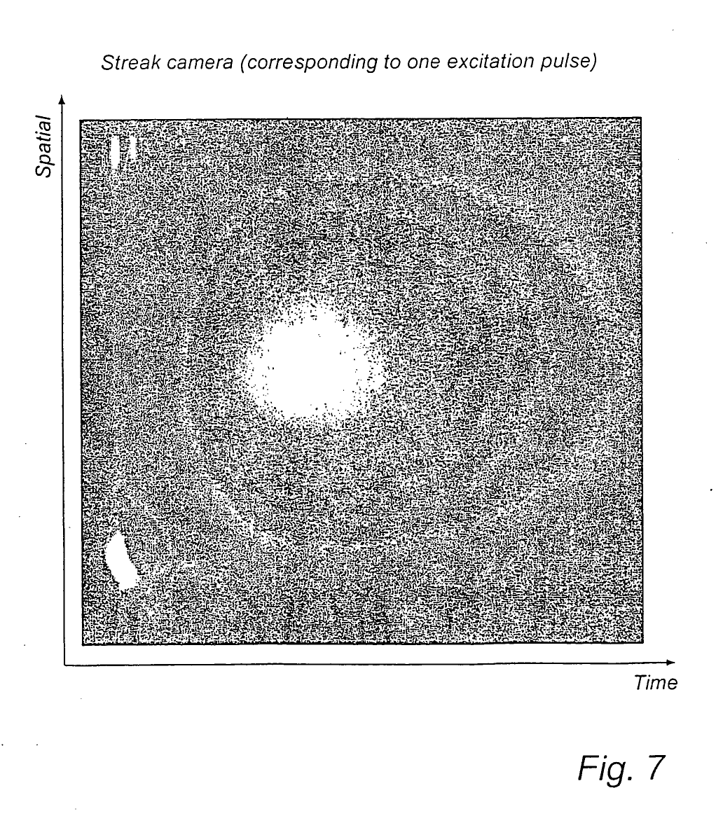

It is possible to combine the above-described aspect with a spatial-resolved intensity detection on the emitted radiation from the object. In this context, the term “spatial resolved” refers to a spatial resolution obtained for each excitation pulse. Especially, “spatial resolved” does not refer to a spatial resolution based on a scanning in time of the excitation beam in relation to the object. As an illustrative example, by removing the water cuvette 22 and the spectrometer 32 in the FIG. 4 set-up, the radiation focused on the entrance slit of the streak camera 34 would be spatial resolved along the slit, corresponding to a “slit” across the object. A streak camera image obtained by such a set-up is illustrated in FIG. 7. In accordance with FIG. 5 discussed above, FIG. 7 represents In one pulse only, i.e. the spatial resolution illustrated does not correspond to any scanning of the excitation beam over the object.

An arrangement analogous to the one shown in FIG. 4 can be used in a process vessel, such as the one shown in FIG. 1 or FIG. 3, wherein the optical probe device of FIG. 2 is used to direct the excitation beam 20 to a monitoring area inside the process vessel 1 and to direct the emitted radiation 30 from the monitoring area to the detection means 32, 34, 36. In the arrangement of FIG. 4, it is the transmitted radiation—the beam 30—which is detected in a time-resolved manner. However, the invention can also be implemented by detecting the radiation reflected from the object. Such an approach will be used in most practical situations, by means of the optical probe device 100, wherein the photons of each excitation pulse will be detected both as directly reflected photons from the front surface of the object(s) (i.e. one or more of the particles shown in FIG. 1 or FIG. 3) as well as diffusely backscattered photons with more or less time delay. This directly reflected radiation as well as the diffusely backscattered radiation is collected by the optical probe device 100.

When using the optical probe device 100 of FIG. 2, the excitation beam is used for diffuse illumination of the monitoring area. However, in other applications, the excitation beam may be focused to a spot in the process vessel (see FIG. 1), or scanned over a monitoring area therein.

Although not illustrated in the drawings, other types of spectrometric measurements could be performed by means of the optical probe 100. In one alternative, time-integrated detection of the emitted radiation is used, and the detected radiation is analyzed as a function of wavelength. For example, by analyzing two-dimensional images generated from radiation transmitted through First and second surfaces of the object(s), the three-dimensional distribution of one or more components in the object(s) can be assessed, for example according to the method disclosed in the applicant's international application with publication number WO 99/49312, which is incorporated herein by reference. A similar assessment can be made from reflected radiation, if the incident excitation radiation has a sufficient penetration depth in the object(s).

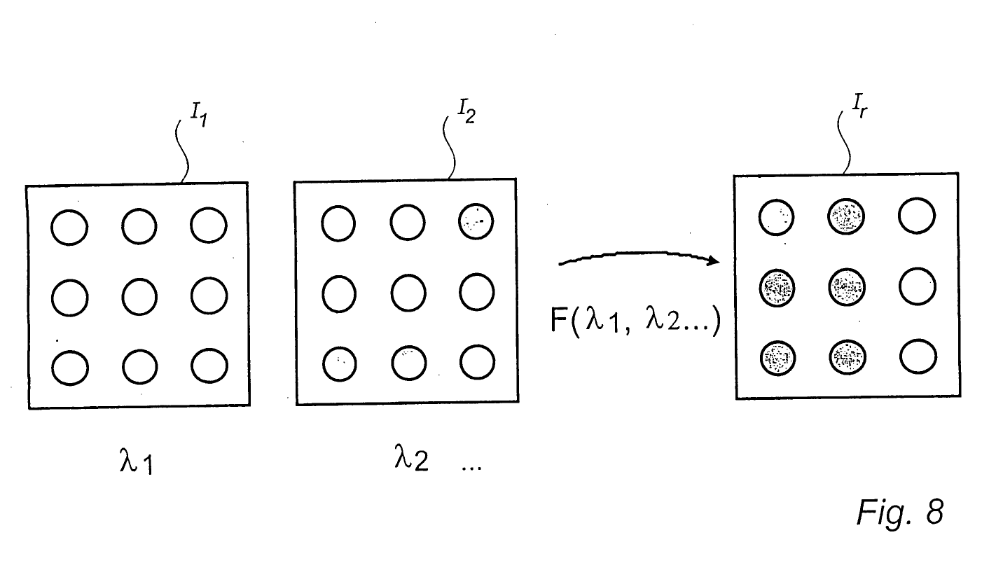

Further, as indicated in FIG. 8, by simultaneously or “quasi-simultaneously” detecting a number of two-dimensional sample images I₁, I₂ (two are shown in FIG. 8), each containing radiation at a unique wavelength or wavelength band λ₁, λ₂, the intensity of the emitted radiation can be analyzed as a function of wavelength in two spatial dimensions, to yield a two-dimensional image Iᵣ of the analytical parameter of interest, for example coating thickness. Alternatively, or additionally, the information in each sample image I₁, I₂ could be used for analysis as a function of wavelength in one spatial dimension. In another implementation, the information in each sample image I₁, I₂, or in a portion thereof, could be integrated for analysis of intensity as a function of wavelength.

It should also be noted that the two-dimensional images I₁, I₂ of the emitted radiation could be used to analyze a single object, such as a particle, in the process vessel. Alternatively, a number of such objects could be analyzed simultaneously so that variations between individual objects are detectable from the image.

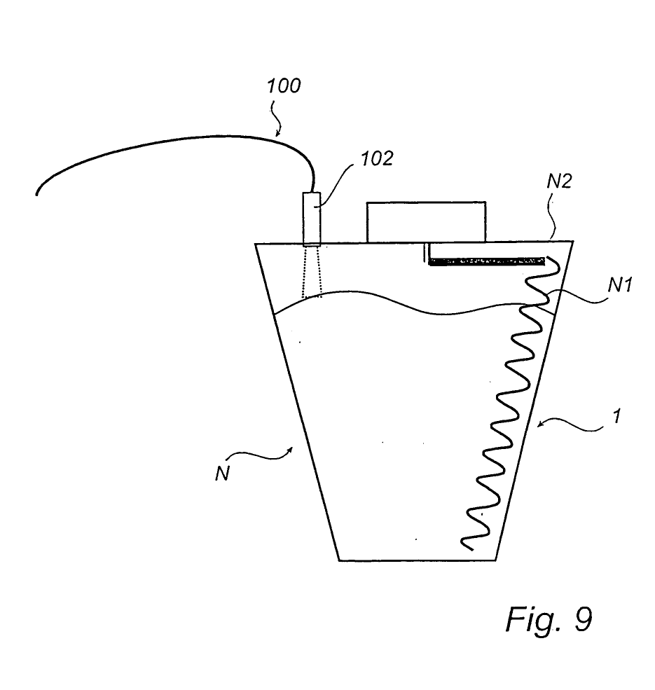

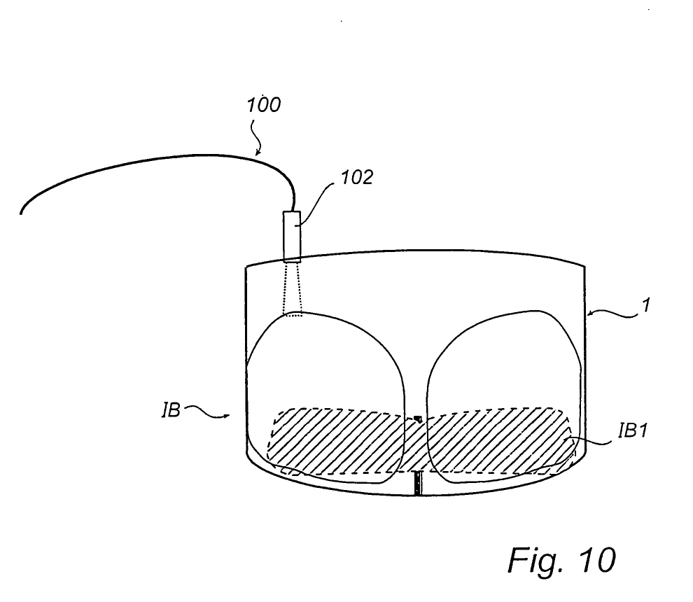

FIGS. 9 and 10 show further examples of how the optical probe device 100 can be installed and used for monitoring in other types of processing apparatuses.

In FIG. 9, physical and/or chemical properties of a pharmaceutical powder blend are monitored during preparation in the process vessel 1 of a convective blender N with an orbiting screw N1 (Nauta-type blender). The orbiting movement of the screw N1 precludes monitoring with physical contact between the probe head 102 and the material in the process vessel 1. Thus, remote sensing is necessary in order to monitor the upper layer of the powder blend. In FIG. 9, the illumination of monitoring area is indicated with dotted lines. Depending on the scale of the blender N (lab-scale, pilot-scale or full-scale), the distance between the lid N2, where the head 102 is interfaced, and the uppermost layer of the powder blend is typically in the range 1-200 cm, normally between about 10 and 50 cm, when the blender N is loaded.

In FIG. 10, physical and/or chemical properties of a pharmaceutical composition are monitored during wet granulation in an intensive blender IB. Here, a large impeller IB1 is positioned at the bottom of the process vessel 1 and a mixture of solids, e.g. powder, and liquid is intensively blended. In this type of apparatus, contact with the material during monitoring should be avoided, since the stickiness of the material might lead to fouling of the probe. Therefore, the probe is operated in a remote mode. The probe head 102 is interfaced with the upper wall of the process vessel 1 and illuminates (indicated with dotted lines) a monitoring area spaced therefrom.

It will be understood that the present invention has been described in its preferred embodiments and can be modified in many different ways without departing from the scope of the invention as defined by the appended claims. In summary, the present invention relates to a fluidized bed apparatus as well as methods for monitoring characteristics of pharmaceutical compositions during preparation thereof. One aspect of the invention is concerned with spectrometric measurements in the wetting zone of a fluidized bed apparatus for preparation of pharmaceutical compositions. Such spectrometric measurements could be made with any suitable technique in any suitable way, with or without an optical probe device. Another aspect of the invention is concerned with using an optical probe device for transmitting a two-dimensional image of emitted radiation from a monitoring area within any type of processing apparatus for preparation of pharmaceutical compositions. In both aspects, the intensity of the emitted radiation can be detected as a function of the wavelength of the emitted radiation, or as a function of both the wavelength of the emitted radiation and the photon propagation time through the monitoring area.

1. Fluidized bed apparatus for preparation of a pharmaceutical composition by a particle-forming process, wherein said apparatus defines a wetting zone (B) into which a processing fluid is injected, and a drying zone in which the processing fluid is at least partly solidified, characterized by a measuring device (11, 11′) which is arranged to perform a spectrometric measurement on the pharmaceutical composition in the wetting zone (B), to thereby monitor characteristics of said pharmaceutical composition during preparation thereof.

2. A fluidized bed apparatus according to claim 1, wherein the measuring device comprises a controller (11′) adapted to control the process on basis, at least partly, of information extracted from the spectrometric measurement.

3. A fluidized bed apparatus according to claim 2, wherein the controller (11′) is arranged to effect feedback control applied to the conditions within the apparatus.

4. A fluidized bed apparatus according to any one of claims 1-3, wherein the measuring device (11, 11′) comprises:
means (S; 12, 13, 16) for generating an excitation beam of radiation;
means (100) for directing the excitation beam of radiation to a monitoring area; in the wetting zone (B) and directing emitted radiation from the monitoring area; and
means (D; 32, 34, 36) for detecting the intensity of the emitted radiation at least as a function of wavelength.

5. A fluidized bed apparatus according to claim 4, wherein the means for generating comprises at least one laser (12, 13, 16), preferably generating a beam of pulsed radiation.

6. A fluidized bed apparatus according to one of claim 4 or 5, wherein the means (32, 34, 36) for detecting is adapted to detect the intensity of emitted radiation from the monitoring area as a function of both the wavelength of the emitted radiation and the photon propagation time through the monitoring area.

7. A fluidized bed apparatus according to claim 6, wherein the means for detecting comprises a time-resolved detection unit (34).

8. A fluidized bed apparatus according to claim 7, wherein the time-resolved detection unit comprises a streak camera (34).

9. A fluidized bed apparatus according to claim 6, wherein the means for detecting comprises a phase-resolved detection unit.

10. A fluidized bed apparatus according to claim 6, wherein the means for detecting comprises a time-gated system.

11. A fluidized bed apparatus according to any of claims 4-10, further comprising means for performing a spatial-resolved detection of said intensity.

12. A fluidized bed apparatus according to any one of claims 4-11, wherein the is excitation beam comprises infrared radiation.

13. A fluidized bed apparatus according to claim 12, wherein the infrared radiation is in the near infrared region (NIR).

14. A fluidized bed apparatus according to claim 13, wherein the radiation has a frequency in the range corresponding to wavelengths of from about 700 to about 2500 nm, particularly from about 700 to about 1300 nm.

15. A fluidized bed apparatus according to any of claims 4-14, wherein the excitation beam comprises visible light.

16. A fluidized bed apparatus according to any of claims 4-15, wherein the excitation beam comprises UV radiation.

17. A fluidized bed apparatus according to any one of claims 4-16, wherein the means for directing comprises an optical probe device (100) capable of transmitting a two-dimensional image of the monitoring area.

18. A fluidized bed apparatus according to claim 17, wherein the optical probe device (100) is capable of directing the excitation beam of radiation to the monitoring area for illumination thereof.

19. A fluidized bed apparatus according to claim 18, wherein the optical probe device (100) provides for diffuse illumination of the monitoring area.

20. A fluidized bed apparatus according to any one of claims 1-19, which comprises a process vessel (1) defining the wetting zone (B) at the axial center thereof and the drying zone at the periphery thereof, surrounding the wetting zone (B), wherein the apparatus is operable to circulate the pharmaceutical compositions through said wetting and drying zones in the process vessel (1).

21. A method for monitoring characteristics of a pharmaceutical composition during preparation thereof by a particle-forming process in a fluidized bed apparatus, wherein said fluidized bed apparatus defines a wetting zone (B) into which a processing fluid is injected, and a drying zone in which the processing fluid is at least partly solidified, characterized by the step of performing a spectrometric measurement on the pharmaceutical composition in the wetting zone (B).

22. A method according to claim 21, further comprising the step of controlling the process on basis, at least partly, of information extracted from the spectrometric measurement.

23. A method according to claim 22, wherein the step of controlling the process comprises effecting feedback control applied to the conditions within the fluidized bed.

24. A method according to any one of claims 21-23, wherein the step of performing a spectrometric measurement comprises:
providing an excitation beam of radiation;
directing the excitation beam of radiation to a monitoring area in the welting zone (B), and directing emitted radiation from the monitoring area, and
detecting the intensity of the emitted radiation at least as a function of wavelength.

25. A method according to claim 24, wherein the emitted radiation is directed from the monitoring area by means of an optical probe device (100).

26. A method according to claim 25, wherein the optical probe device (100) transmits a two-dimensional image of the monitoring area.

27. A method according to claim 25 or 26, wherein the excitation beam of radiation is directed to the monitoring area by means of the optical probe device (100), preferably for diffuse illumination of the monitoring area.

28. A method according to any one of claims 24-27, wherein the step of directing emitted radiation includes transmitting at least one two-dimensional image (I₁, I₂) of the emitted radiation from the monitoring area to a detection means (D; 32, 34, 36), which extracts a measurement signal from the two-dimensional image (I₁, I₂).

29. A method of monitoring physical and/or chemical properties of a pharmaceutical composition during preparation thereof in a process vessel (1), said method comprising the steps of:
providing an excitation beam of radiation;
directing the excitation beam of radiation to a monitoring area in the process vessel (1) by means of an optical probe device (100); and
directing emitted radiation from the monitoring area by means of the optical probe device (100) and detecting, in a detection means (D; 32, 34, 36), the intensity of the emitted radiation at least as a function of the wavelength of the emitted radiation, characterized in that the step of directing emitted radiation includes transmitting at least one two-dimensional image of the emitted radiation from the monitoring area to the detection means (D; 32, 34, 36).

30. A method according to claim 29, further comprising the steps of extracting information from the detected intensity and controlling the process on basis, at least partly, of the information.

31. A method according to claim 30, wherein the step of controlling comprises effecting feedback control applied to the conditions within the process vessel (1).

32. A method according to any one of claims 24-31, wherein the emitted radiation comprises diffusely reflected radiation from the monitoring area.

33. A method according to any one of claims 24-31, wherein the emitted radiation comprises transmitted radiation as well as diffusely reflected radiation from the monitoring area.

34. A method according to any one of claims 24-33, wherein the excitation beam includes laser radiation.

35. A method according to any one of claims 24-34, wherein the excitation beam includes pulsed laser radiation.

36. A method according to any one of claims 24-35, wherein the excitation beam is intensity modulated in time.

37. A method according to any one of claim 24-36, wherein the step of directing emitted radiation includes transmitting a number of two-dimensional images (I₁, I₂) to the detection means (D; 32, 34, 36), each image containing emitted radiation in a specific wavelength range (λ₁, λ₂).

38. A method according to any one of claims 24-37, wherein the intensity of the emitted radiation from the monitoring area is detected as a function of both the wavelength of the emitted radiation and the photon propagation time through the monitoring area.

39. A method according to claim 38, wherein the excitation beam is a pulsed excitation beam presenting a pulse train of excitation pulses (P), and wherein the step of detecting the intensity as a function of the photon propagation time is performed in time synchronism with said excitation pulses (P).

40. A method according to claim 39, wherein the excitation pulses (P) have a pulse length shorter than the photon propagation time.

41. A method according to claim 40, wherein the excitation pulses (P) have a pulse length selected short enough in relation to the photon propagation time such that any undesired interference between intensity measurements relating to two subsequent excitation pulses is prevented.

42. A method according to any one of claims 38-41, wherein the excitation beam is an intensity modulated excitation beam.

43. A method according to claim 42, wherein the step of detecting the intensity as a function of the photon propagation time is performed by comparing the phase of the intensity modulated excitation beam with the phase of the emitted radiation from the monitoring area.

44. A method according to claim 42 or 43, wherein the step of detecting the intensity as a function of the photon propagation time is performed by comparing the modulation depth of the intensity modulated excitation beam with the modulation depth of the emitted radiation from the monitoring area.

45. A method according to any one of claims 38-44, wherein said detection of the intensity of emitted radiation from the monitoring area as a function of time is performed by the use of a time-resolved detection unit.

46. A method according to any one of claims 38-44, wherein said detection of the intensity of emitted radiation from the monitoring area as a function of time is performed by the use of a phase-resolved detection unit.

47. A method according to any one of claims 38-44, wherein said detection of the intensity of emitted radiation from the monitoring area as a function of time is performed by the use of a time-gated system.

48. A method according to any one of claims 24-47, wherein said step of detecting the intensity further includes a spatial-resolved detection of said intensity.

49. A method according to any one of claims 24-48, wherein the excitation beam comprises infrared radiation.

50. A method according to claim 49, wherein the infrared radiation is in the near infrared region (NIR).

51. A method according to claim 50, wherein the infrared radiation has a frequency in the range corresponding to wavelengths of from about 700 to about 2500 nm. particularly from about 700 to about 1300 nm.

52. A method according to any one of claims 24-51, wherein the excitation beam comprises visible light.

53. A method according to any one of claims 24-52, wherein the excitation beam comprises UV radiation.

54. An optical probe device (100) for use in a fluidized bed apparatus according to any one of claims 4-20, or in a method according to any one of claims 25-53, comprising means (108) for directing the excitation beam of radiation from a distal end to a proximal end for illumination of the monitoring area, and means (104, 106) for transmitting a two-dimensional image of the monitoring area from the proximal end to the distal end.

55. An optical probe device according to claim 54, wherein the proximal end of the probe is provided with a hydrophilic coating.

56. An optical probe device according to claim 54 or 55, comprising a gas flusher which generates a flow of gas over the exterior of the proximal end.

57. An optical probe device according to any one of claims 54-56, wherein the means for transmitting comprises an imaging system (104) at the proximal end, and an image-guiding optical fiber element (106) which is optically coupled to the imaging system (104).

58. An optical probe device according to claim 57, wherein the image-guiding optical fiber element (106) includes a coherent assembly of optical fibers.

59. An optical probe device according to claim 57 or 58, wherein the imaging system (106) provides for adjustment of the size of the monitoring area.

60. An optical probe device according to any one of claims 57-59, wherein the imaging system (106) provides or adjustment of focal length.

61. An optical probe device according to any one of claims 54-60, wherein the means for directing the excitation beam comprises an excitation beam transmitting optical fiber assembly (108) which extends from the proximal end.

62. An optical probe device according to claim 61, wherein the excitation beam transmitting optical fiber assembly comprises single optical fibers (108) which are arranged in at least one annulus at the proximal end.

63. The fluidized bed apparatus according to claim 62 in combination with any one of claims 57-59, wherein the at least one annulus is concentric with the imaging, system (104) and arranged radially outside the perimeter thereof, as seen towards the proximal end.
